(19) United States
(12) Patent Application Publication
(10) Pub. No.: US 2022/0390566 A1
(43) Pub. Date: Dec. 8, 2022

(54) OPTICAL ASSEMBLY FOR LIDAR DETECTION SYSTEM

(71) Applicant: QLM Technology Limited, Bristol (GB)

(72) Inventors: Xiao Ai, Bristol (GB); James Titchener, Bristol (GB); Murray Reed, Bristol (GB); Alexander Dunning, Bristol (GB)

(73) Assignee: QLM Technology Limited, Bristol (GB)

(21) Appl. No.: 17/663,102

(22) Filed: May 12, 2022

Related U.S. Application Data
(60) Provisional application No. 63/202,378, filed on Jun. 8, 2021.

(51) Int. Cl. G01S 7/481; G01S 17/89; G02B 27/28

(52) U.S. Cl. CPC G01S 7/4812; G01S 17/89; G01S 7/4813; G02B 27/283

(57) ABSTRACT

An optical assembly for a laser projection and return laser light detection device comprises a housing; a first series of components arranged in the housing to define an exit path for laser radiation entering from a laser source and then exiting from the housing; a second series of components arranged in the housing to define a return path for scattered returns of the laser radiation entering the housing and passing to a detector; a polarising beam splitter/combiner common to the exit path and the return path arranged to polarise laser light exiting from the housing and to separate scattered laser light returned to the assembly, that is orthogonally polarised to the exiting laser radiation. The polarising beam splitter/combiner forms a window to the housing.

### CROSS-REFERENCE TO RELATED APPLICATION

The present application claims the benefit of priority of U.S. Provisional Patent Application No. 63/202,378, filed Jun. 8, 2021, the entire disclosure of which is incorporated herein in its entirety by reference.

The invention is in the field of detection and imaging systems.

In a laser projection and return device of the kind used in gas detection for example, the design of the optical assembly, for directing the projected and returned radiation is critical to the detection of small amounts of gas.

In the following various optical assemblies are described that improve on existing designs in various ways.

In one aspect there is provided in the following an optical assembly for a laser projection and return laser light detection device comprising: a housing; a first series of components arranged in the housing to define an exit path for laser radiation entering from a laser source and then exiting from the housing; a second series of components arranged in the housing to define a return path for scattered returns of the laser radiation entering the housing and passing to a detector; a polarising beam splitter/combiner common to the exit path and the return path arranged to polarise laser light exiting from the housing and to separate scattered laser light returned to the assembly, that is orthogonally polarised to the exiting laser radiation; herein the polarising beam splitter/combiner forms a window to the housing.

There is also provided a transceiver system comprising the optical assembly and a laser projection and return device comprising the transceiver system.

### BRIEF DESCRIPTION OF THE DRAWINGS

Embodiments of the invention will be described, by way of example only and with reference to the following drawings, in which:

FIG. 1 is a schematic diagram of the basic architecture of a gas lidar system;

FIG. 2 is a schematic diagram of a coaxial gas lidar system;

FIG. 3 is a schematic diagram of an optical assembly;

FIG. 4 is a schematic diagram of an optical assembly according to some embodiments of the invention;

FIG. 5 is a schematic diagram of an optical assembly similar to that of FIG. 4, further comprising a focussing component in the exit path and a collimating component in the return path;

FIG. 6 is a schematic diagram of an optical assembly similar to that of FIG. 4, indicating components that may be super-polished;

FIG. 7 is a perspective view showing an example optical layout of the components shown in FIGS. 5 and 6;

FIG. 8 is a perspective view similar to FIG. 7 with the addition of additional polarisers in the laser output and return signal paths to increase the polarisation rejection of reflected laser light back into the detector;

FIG. 9 is a diagram of a mechanical and optical design similar to FIG. 8 with the addition of a black box around the detector to decrease the laser scattered light back into the detector;

FIGS. 10a, 10b, 10c are perspective views of a mechanical and optical design for a housing to hold a polariser cube window designed to allow the use of the maximum aperture of the exit face of the polariser cube;

FIGS. 11a and 11b are two perspective views similar to FIG. 8 with the addition of elements in the common laser output and return signal path to project the laser beam and collect the return light;

FIG. 12 is a diagram of an optical assembly with the addition of a polarisation element in the common laser output and return signal path to increase the portion of reflected laser beam that is returned to the detector light.

Common reference numerals and other indicators are used throughout the figures to indicate similar features.

### DETAILED DESCRIPTION

High-sensitivity, low-power, remote gas detection and imaging systems are being developed based on semiconductor infrared lasers, single-photon detectors and quantum technology. An example application for this technology is the remote detection and quantification of leaks from natural gas wells and pipelines to locate, quantify and map fugitive emissions.

GB2586075A discloses a gas sensor using a combination of two laser technologies known as Single Photon LiDAR and Tuneable Diode Laser Absorption Spectroscopy (TDLAS) designed to provide a fast, accurate leak identification, quantification, and mapping system to meet the commercial needs of oil and gas producers for high-speed sensing and large survey coverage area at a small fraction of the operational costs of their existing solutions. The sensor shown in GB2586075A is one example of a laser projection and return laser light detection device in which the optical assemblies described here may be implemented.

Lidar (Light Detection And Ranging) is the most common denomination for a variety of technologies based on the detection of laser light after propagation and return in free space. Lidars are also called ladars (laser detection and ranging), laser radars, laser range finders and laser telemeters. The large variety of LiDAR types ranges from low power low cost consumer applications (face identifier in smartphones, sensors for self-driving cars . . . ) to high power and extremely complex space-borne instruments, such as the Atmospheric Laser Doppler Instrument of the European Space Agency in AEOLUS mission.

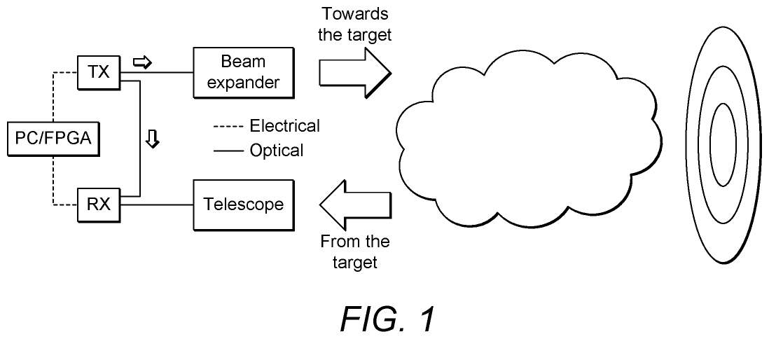

The basic architecture of a LiDAR system is depicted in FIG. 1. The laser transmitter (TX) works either in Continuous Wave (CW), pulsed condition, or under modulation, and the beam is launched through a lens system, beam expander or telescope. The reflected signal is detected by the receiver (RX), and electronically processed to derive the distance to the target and other information. Depending on the system, the RX also needs a fraction of the emitted light as reference or as local oscillator to beat against the returned signal on the detector.

The original LiDAR distance measurement has been extended to measure many new parameters including the velocity of remote objects, the quantity and type of gas the laser passes through, and the velocity of the air.

Single Photon LiDAR is a very active field with multiple research groups working on long distance measurement. Geiger-mode single-photon lidar systems, originally developed by MIT Lincoln Laboratories have been made commercially available and used for long distance observations of the Earth's surface. For example, Zheng-Ping Li et al, Single Photon imaging over 200 km, Optica Vol. 8, No. 3 p 344 March 2021, present a single photon lidar system that uses “optimized compact coaxial transceiver optics”. The transceiver optics is the optical system that transmits the lidar beam out of the laser source into the environment and then receives the scattered return light back from the environment and directs it into the single photon detector. In some aspects the present invention provides improved transceiver optics, for example in the form of an optical assembly. In other aspects the invention provides a gas lidar detection apparatus including the improved transceiver optics.

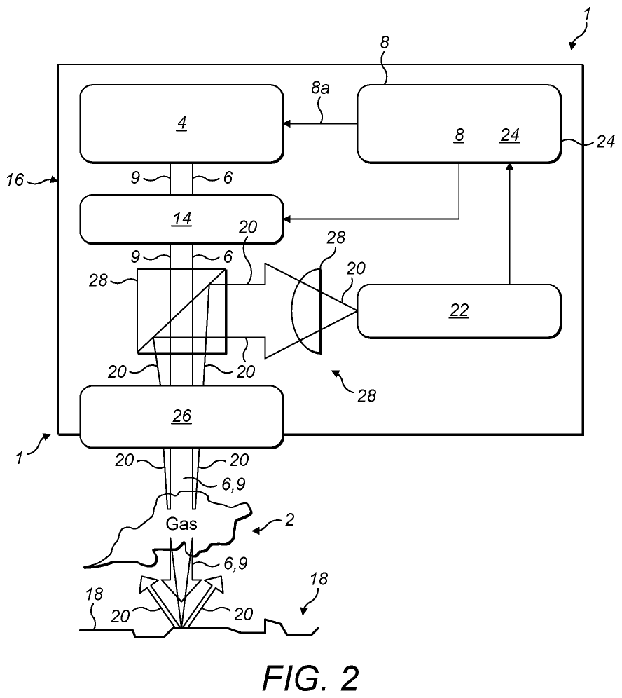

FIG. 2 is a schematic diagram of a single photon lidar system, described in further detail in GB2586075A as an optical gas detection device. The gas detection device configured to detect the presence or concentration of at least one gas 2.

In the system of FIG. 2, a laser device 4 is operable to output first output radiation 6 having a continuous wave output. A control element 8 is operable to tune a first emission wavelength 9 of the first output radiation 6 continuously within a first wavelength spectrum .

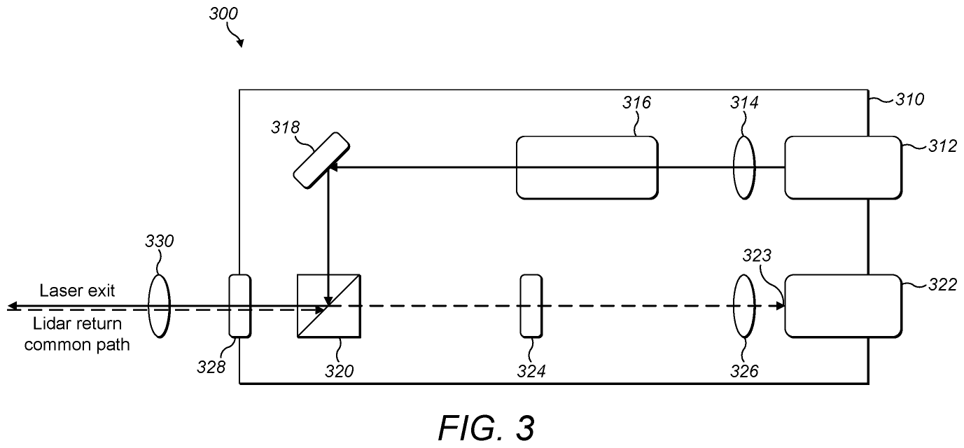

As shown, the device 1 includes a modulator 14 operable to apply a first output modulation 16 to the first output radiation 6. The output radiation is passed through a polarising beam splitter/combiner 28 such that output radiation is one polarisation. Further, the device 1 includes an optical system 26 operable to transmit the first output radiation 6 towards a first target location 18 and to collect/receive scattered radiation 20, the scattered radiation 20 having been at least partially modified by the absorption of the gas 2 present in the first target location 18. The scattered radiation is also at least partially modified by the scatter surface itself to now include a component of polarisation orthogonal to the output radiation 6. This orthogonal polarisation scattered radiation 20 is therefore reflected rather than transmitted by the polariser beam splitter 28. A detector 22 is configured to receive this reflected scattered radiation 20 and a processing element 24 operable to process the signal from detector 22 produce by the received scattered radiation 20. The optical system 26 and the polarising beam splitter/combiner 28 may be provided as an optical assembly, examples of which are shown in more detail in FIGS. 3 to 16.

Any of the optical assemblies described here may provide a single-photon lidar optical design with collinear confocal input and output beam paths and polarisation discrimination between them. However the optical assemblies are not only useful in single-photon lidar devices and may have other implementations.

Additionally or alternatively the optical assemblies may be designed to minimise the number and shape of common exit path surfaces and use super-polishing and low scatter optical coating of those surfaces to reduce crosstalk into the detector and allow higher laser output power. “Super-polishing” is a classification for optical surface roughness. A super-polished surface has roughness features measurable only in angstroms, typically less than one angstrom. Super-polishing is a widely known technique to make very high reflecting and high laser damage threshold mirrors, called super-mirrors. It is less widely used to make very low scatter transmission optics like windows and is not known to be used in in single-photon systems.

FIG. 3 is a schematic diagram of an optical assembly 300. The assembly of FIG. 3 comprises a housing 310.

A first series of components is arranged in the housing 310 to define an exit path for radiation entering the housing 310 from a laser source 312 and then exiting from the housing. In other words the first series of components may be arranged to direct radiation entering the housing to an exit, for example an exit window in the housing to be described further below. The exit path is shown in solid lines within the rectangle representing the housing 310. In FIG. 3 the laser source 312 is shown to be mounted in an opening of the housing 310. Other arrangements of the laser source 312 with respect to the housing 310 are possible, for example it may be outside the housing 310 or completely enclosed in the housing 310. In FIG. 3 the first series of components comprises a collimating lens 314 for the laser radiation, a gas reference cell 316, a mirror 318 and a polarising beam splitter/combiner 320. Additional components may be provided, for example if the exit path has a different shape from that illustrated. Alternatively not all of the illustrated components may be required to define the exit path in some embodiments.

A second series of components is arranged in the housing to define a return path for scattered returns of the laser radiation entering the housing 310 and passing to a detector 322. In other words the second series of components may be arranged to direct radiation entering the housing via the window to the detector 32. The return path is shown in dotted lines within the rectangle representing the housing 310. The detector 322 is shown to be mounted in an opening of the housing 310. As with the laser source 312 the detector 322 may alternatively be outside the housing 310 or completely enclosed in the housing 310. The end face 323 of the detector 322 is shown to face into the interior of the housing 310. In FIG. 3 the second series of components comprises the polarising beam splitter/combiner 320, a wavelength filter 324, and a lens 326 for focussing radiation onto the detector 322.

In the illustrated optical assemblies, the exit and return paths within the housing are not coincident. Parts of the exit and return paths may be parallel to each other.

Notably in the assembly of FIG. 3 the first series of components comprises a gas reference cell that provides a calibrated example of the absorption of the gas being measured and the second series of components does not comprise a gas reference cell. In principle, the gas reference cell may be positioned in either the exit path or the return path or a path that is common to exit and return. Providing the gas reference cell in the exit path only enables the size of the housing to be reduced as one or more filters, for example filter 324, are needed to be present in the return path and are most effective when placed close to the detectors. The provision of the gas reference cell in the common path has the advantage of 2× longer effective pathlength for the radiation which is good, but as it leads to more laser to detector feedback this is not always preferred.

The polarising beam splitter/combiner 322 is common to the exit path and the return path. In other words the same polarising beam splitter/combiner 322 is shared between the exit path and the return path. The polarising beam splitter/combiner 322 is arranged to polarise laser light exiting from the housing and to separate scattered laser light returned to the housing, that is orthogonally polarised to the exiting laser radiation, from other radiation returned to the assembly. In this configuration polarized output laser radiation passes off (or through) the polarising beam splitter/combiner 322 and exits as incident radiation on a target, from which it is reflected or scattered. Reflected returned light is generally the same polarization as the incident radiation while scattered returned light is generally depolarised. The polarising beam splitter/combiner 322 operates such that the portion of the returned signal light that is orthogonally polarized to the exiting radiation passes though (or off) the polarising beam splitter/combiner 322. Since reflected returned light is generally the same polarization as the output while scattered returned light is generally depolarised this configuration strongly rejects reflection returns compared to scattered returns.

A window is generally provided in the housing 310 to prevent the performance of the optical assembly from being degraded, due for example to the ingress of dust or dirt into the housing. Thus in the assembly of FIG. 3 a window 328 is provided in the housing 310. A window as defined here is optically transparent and provides a physical barrier to particles entering the housing.

The assembly of FIG. 3 also comprises a telescope lens 330 outside the housing arranged to collect laser radiation entering the housing and to project laser radiation exiting the housing. The telescope lens and the beam splitter/combiner 320 form a common exit and return path outside the housing for laser radiation. Any one or more optical components may be provided outside the housing to define the common exit and return path, for example to collect laser radiation entering the housing and to project laser radiation exiting the housing.

Components provided outside the housing of the optical assembly for laser projection and return laser light detection may for example be accommodated in a larger housing, which may enclose the housing of the optical assembly.

The optical assembly together with the laser source 312 and the detector 322 form a transceiver system.

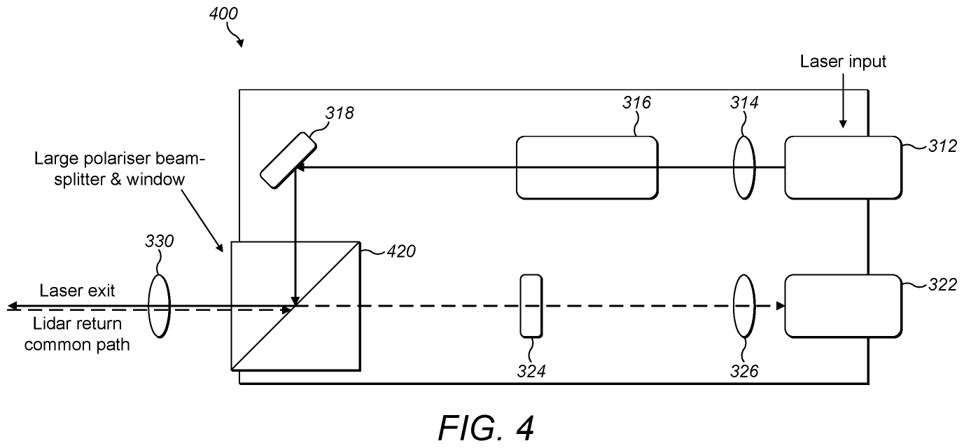

The present inventors have found that it is advantageous to minimise the optical surfaces in the common exit/return path. An example of how this may be achieved is now described with reference to FIG. 4.

FIG. 4 is a schematic diagram of an optical assembly 400 according to some embodiments of the invention. The assembly of FIG. 4 generally corresponds to that of FIG. 3. An important difference is that the polarising beam splitter/combiner 420 forms the window to the housing 310 and therefore the separate window 328 is not required. The polarising beam splitter/combiner 420 itself forms a barrier to dust and debris. In FIG. 4, the size of the beam splitter/combiner 420 is larger than the beam splitter/combiner 320. In general it is desirable for the beam splitter/combiner 420 to be as large as the design and cost constraints allow. The larger the prism exit face of the beam splitter/combiner 420, i.e. the face exposed to the exterior, the more the exit laser beam can be defocussed and the less feedback is received at the detector. By moving the beam splitter/combiner 420 to form a window, the present inventors were able to double the width of the beam exit face, for example from using a 5 mm wide polariser to a 10 mm wide polariser.

It should further be noted in connection with FIG. 4 that no additional components are required to direct radiation from a window in the housing to the polarising beam splitter/combiner 320.

The use of the beam splitter/combiner 420 as a window and the fact that it is larger than beam splitter/combiners used hitherto both contribute to reducing the amount of laser power reflected or scattered back into the detector. This back scattering may originate from additional components between the beam splitter/combiner and the target, and from the surfaces of the beam splitter/combiner 420. The polariser is therefore made larger and the original window 328 is now removed so there is no scatter back from it anymore. Additional surfaces that are well coated, far away and tilted off the beam axis do not feedback into the detector very strongly so it is mainly the close-in and not highly tilted ones, like the window, that it is desired to remove.

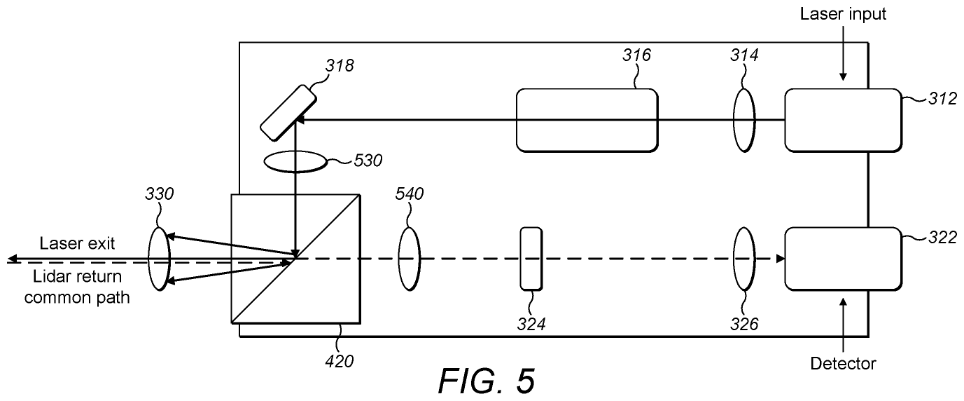

According to some embodiments of the invention, the first series of components may comprise one or more components arranged to focus laser radiation in the exit path inside the housing so that the laser beam radiation passing off or though the polariser is spatially diverging. Additionally or alternatively the second series of components may comprise one or more components arranged to collimate laser radiation in the return path. This is shown schematically in FIG. 5.

FIG. 5 is a schematic diagram of an optical assembly similar to that of FIG. 4, with a polarising beam splitter/combiner forming a window to the housing 310, and further comprising a focussing component in the exit path and a collimating component in the return path. Similar components may be provided in the assembly shown in FIG. 3.

In FIG. 5 the focussing component comprises a lens 530 in the exit path. The lens 530 may be at any suitable position in the exit path. In the example of FIG. 5 the lens 530 is positioned as the last component in the exit path before the beam splitter/combiner 420. The focussing the output laser beam, before it reaches the beam splitter/combiner, results in the beam output from the housing diverging in the common exit and return path. This reduces the amount of laser power reflected and scattered back into the detector 322. In particular, the diverging laser beam reflections and scatter that are returned towards the detector 322 are therefore spread in larger lateral dimensions outside the collection aperture of the return path optical system through lens 540 and lens 326 that is designed to focus the return light onto the detector.

In FIG. 5 the collimating component comprises a lens 540 in the return path. The lens 540 may be at any suitable position, in FIG. 5 it is shown to be the first component in the return path after the beam splitter/combiner 420.

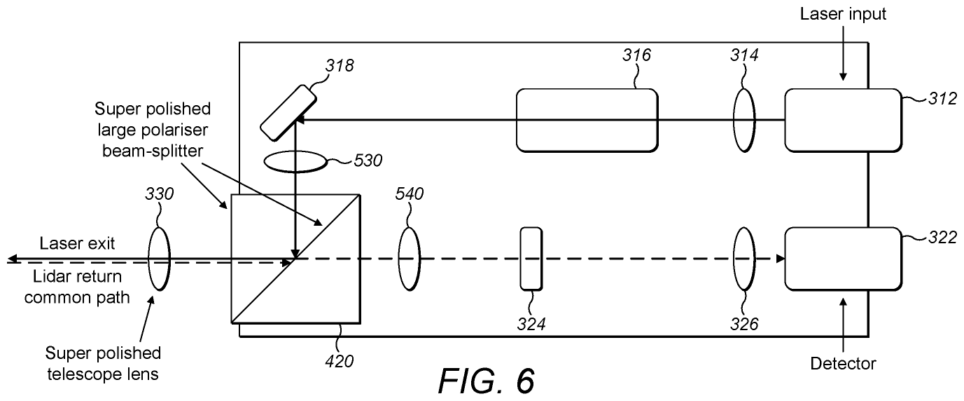

In some embodiments of the invention the optical surfaces of the beam splitter/combiner 320 or 420 and/or optical surfaces of other optics in the common exit and return path have low-scatter super-polished surfaces. This is shown schematically in FIG. 6. Super-polishing is expensive and not available on all optical components. Scatter off the other optical components not in the common path is not in line with the return path so only produces stray light and does not contribute to the feedback if baffles and/or shields are positioned around the detector as described further below.

FIG. 6 is a schematic diagram of an optical assembly similar to that of FIG. 4, indicating components that may be super-polished, in this example the polarising beam splitter/combiner 420 and the telescope lens 330. In some embodiments only components, or parts of components, exposed to an atmosphere outside the housing may be super-polished. Thus for example only the external surface of the beam splitter/combiner 420 may be super-polished, with other surfaces inside the housing having a rougher surface. Also the telescoping lens 330 may be super polished but other lenses or other components inside the housing 310 may not be super-polished.

The use of super-polished surfaces as described with reference to FIG. 6 may be used with any of the assemblies shown in or described with reference to FIGS. 3, 4 and 5.

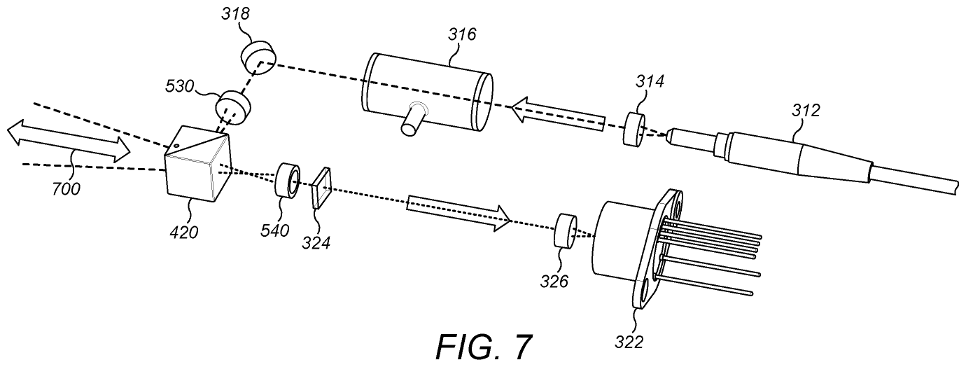

FIG. 7 is a perspective view showing an example optical layout of the components shown in FIGS. 5 and 6 in which like components are indicated with the same reference numerals. It will be appreciated that the components of FIGS. 3 and 4 may be arranged in a similar layout.

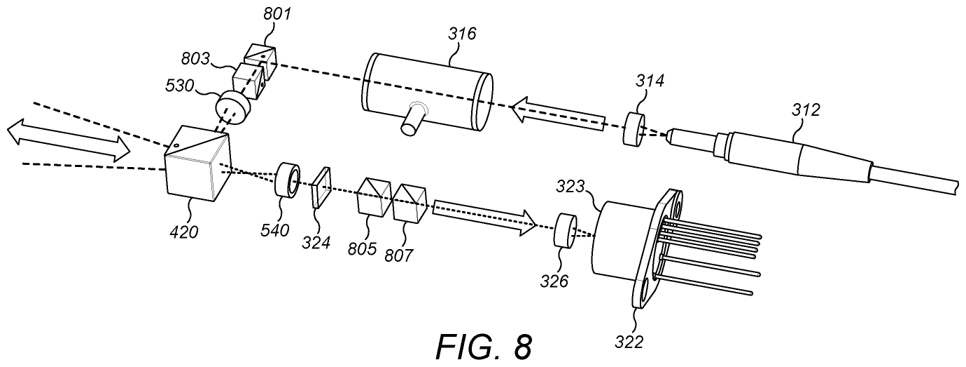

In any of the assemblies described here, one or more additional polarisers may be provided in one or both of the laser exit and return paths to increase the polarisation rejection of reflected laser light back into the detector. The additional polarisers may be used to reinforce the selection of the common polariser 320 or 420 and therefore polarisers in the respective exit and return paths may be arranged to act orthogonally. Notably the components in the common path, outside the housing in the illustrated assemblies, are chosen to pass both polarisations. Thus, the first series of components that defines the exit path may comprise one or more additional polarisers. Additionally or alternatively the second series of components that defines the return path may comprise one or more additional polarisers. An example of this is illustrated in FIG. 8.

FIG. 8 is a perspective view similar to FIG. 7 showing additional polarisers. Additional polarisers may be similarly provided in any of the optical assemblies described here. In FIG. 8, in the exit path, the mirror 318 is replaced by a polariser 801 and an additional polariser 803 is positioned between the polariser 801 and the lens 530. In the return path, two additional polarisers 805, 807 are positioned between the lens 326 and the filter 324. The reinforcement of polarisation with multiple polarisers is known. The ratio a polariser outputs in ‘good vs ‘bad’ polarisation is called its extinction ratio. If one polariser has a ratio of 20 dB then two polarisers have 40 dB etc. The number of additional polarisers in each of the exit and return paths may be the same or different depending on the characteristics of the polarisers themselves.

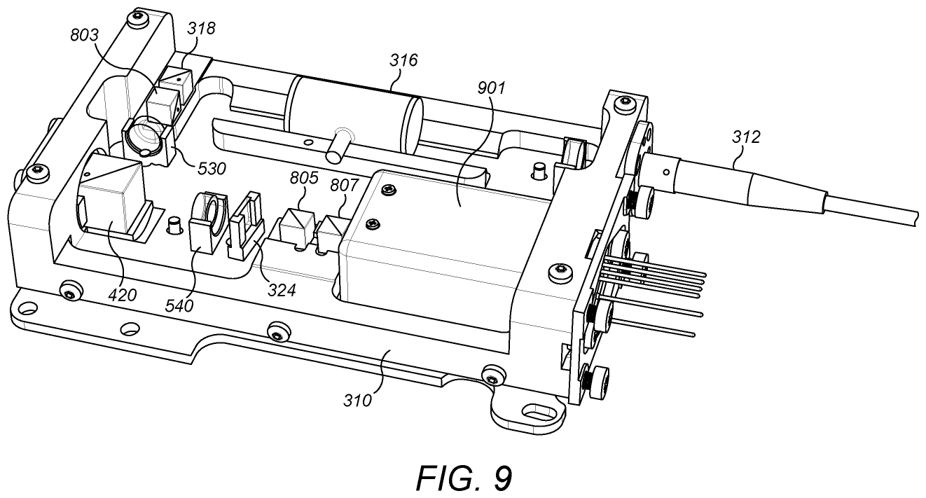

In any of the assemblies described here, one or more mechanical components may be provided to limit the optical path to the detector. An example is shown in FIG. 9.

FIG. 9 is a perspective view similar to FIG. 8 additionally showing part of the housing 310 in which the components are located. The detector is enclosed in a box 901, for example a black box that will absorb any radiation that impinges on it. The box 901 may be partially formed from the housing 310. The box 901 may be designed such that, for example together with the housing 301, only the end face 323 of the detector 322 is exposed to the interior of the housing 310. It will be appreciated that the effect of the box 901 is to decrease scattered laser light back into the detector 322. The scattered light mentioned here refers to ‘stray’ scattered light that comes from the laser beam in the exit path. This includes scattering off optical surfaces, laser leakage through mirrors that then scatters off mechanical surfaces, and rejected laser reflections off polarisers that then scatter off mechanical surfaces. All this bounces around in many directions and floods the housing 310 and therefore it is desirable to stop it before it reaches the detector. A single photon signal may have power less than 1 pW and therefore 100 dB of rejection of the 10 mW laser output is desired. The box 901 is an example of a mechanical construction arranged in the housing to baffle and limit the optical path passed to the detector and prevent stray scatter light from the laser exit beam returning to the detector 322.

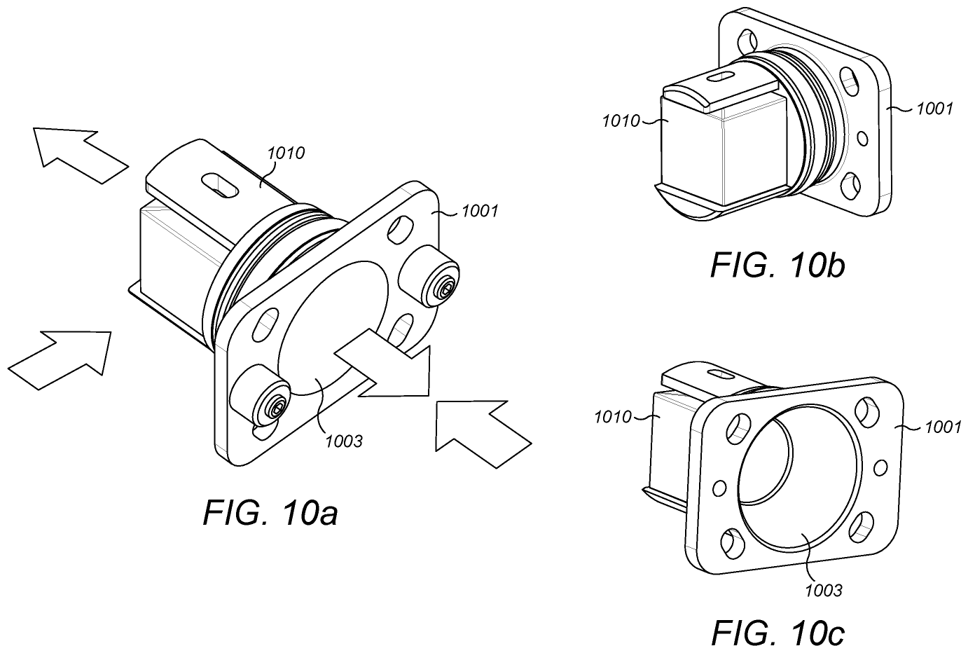

FIGS. 10a, 10b and 10c are perspective views showing an example optical and mechanical configuration of the beam splitter/combiner 420 with respect to the housing 310. In this example, a housing component 1001 is designed to be screwed to the front of the housing 310 and to define an aperture 1003 to be closed by a window, in this example a polarising beam splitter/combiner indicated by reference 1010 which may be the same as or similar to the beam splitter/combiner 420. The configuration may be designed to allow the use of the maximum aperture of the exit face of the beam splitter/combiner, which is usually cuboidal and has a square end face. As shown the aperture 1003 is circular and is designed to have a diameter as close as possible to the width of the beam splitter/combiner end face, which is typically square. This configuration of housing and beam splitter/combiner may be used in any of the optical assemblies described here.

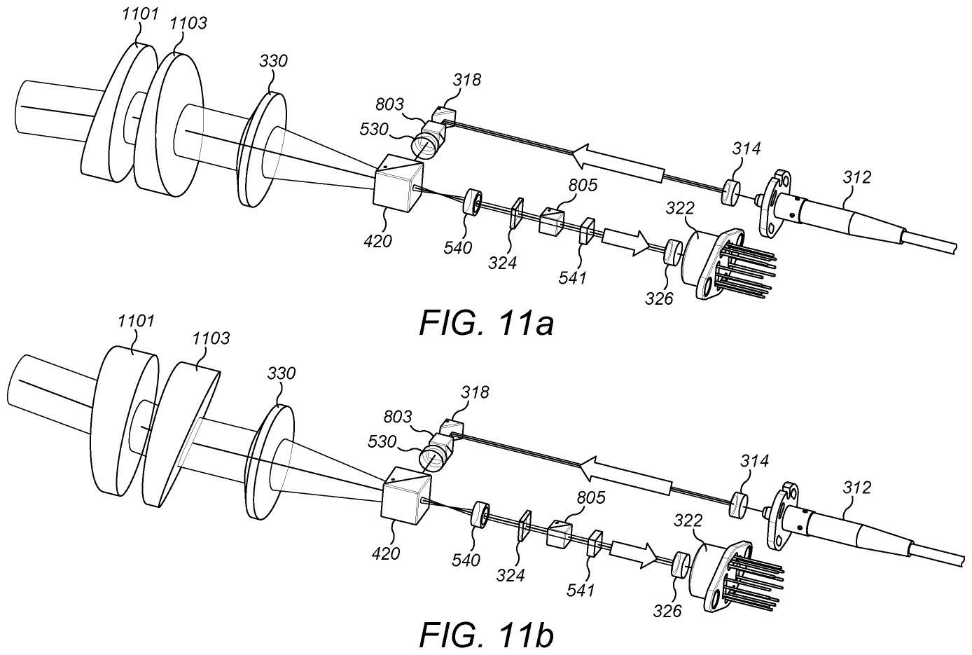

FIGS. 11a and 11b are two perspective views similar to FIG. 8 including additional polarisers, in this example including additional polarisation components 803 in the exit path and 805 in the return path. Other additional components include a second optical filter 541 as well as the first filter 540. The gas cell in previous figures is omitted for clarity. Each of FIGS. 11a and 11b shows the addition of components 1101, 1103 in the common laser exit and return signal path, outside the housing 310 not shown in these figures, to project the laser beam and collect the return light. This example shows two beam steering prisms that rotate to steer the laser beam down in FIG. 11a and up in FIG. 11b. These may be present in any of the optical assemblies described here. One or more of these additional components may see larger laser beam diameters than the window/beam splitter/combiner. Additionally or alternatively one or more of them may be arranged off-axis from the laser beam. Being further away from the detector than other components, any feedback from them to the detector 322 is significantly less than from other components.

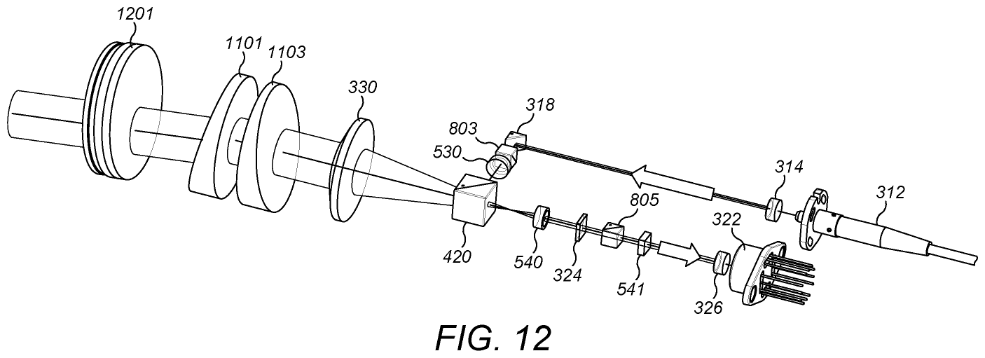

FIG. 12 is a perspective view similar to FIG. 11 with the addition of a polarisation component 1201 in the common laser output and return signal path to change the polarisation of laser light and increase the portion of reflected laser beam that is returned to the detector light. This additional polarisation component may be present in any of the optical assemblies described here. This additional component may act as a wave plate/retarder in the common exit and return path. Only one is shown here but more than one wave plate/retarder may be provided.

Some of FIGS. 3 to 12 include dimensions of components by way of example only and the invention is not limited to particular dimensions. In some embodiments the relative dimensions of one or more components with respect to one or more other components may be significant.

The optical assembly or transceiver system according to this invention may have any one or more of the following features, which may be generally categorized as low backscatter design features, polarisation/depolarisation design features, and other features:

Low Backscatter Design Features:
Super-polished optics to reduce backscatter from laser into the detector. This is indicated by way of example in FIG. 6 where the beam splitter/combiner has super-polished surfaces. Such surfaces may also be present at other parts of the systems shown in the figures.
Reduced number of components in the common path. This is indicated in FIG. 4 for example where the internal gas reference cell is placed in the transmit path only to reduce backscatter.
Laser beam configured so it is optically diverging through the output surface(s) so as to reduce backscatter into the detectors. This is indicated in FIG. 5 for example.
Use of beam splitter/combiner cube, optionally sealed, as an output surface to reduce backscatter. This can be seen in FIGS. 4 through 6 where a beam splitter/combiner cube is attached to the housing so that an additional transmissive window in the housing may not be required. An optical mechanical design for such a polariser window is shown in FIG. 10.
Blackening internal walls where the laser beam may have secondary paths so as to reduce backscatter, as indicated for example in FIG. 9.
Blackening and baffling the lidar return optical channel so as to reduce backscatter, as indicated for example in FIG. 9.

Polarisation and Depolarisation Design Features:
Using a wave plate/retarder as the last optic to maximise signal return from polarisation preserving reflecting objects like the surface of water. This can be seen in FIG. 12 where a polarisation element is added to the common laser output and return signal path after the beam telescope and beam scanning optical components seen in FIG. 11.
Additional polarization filtering in the transmit and receive paths to reduce cross-talk. This can be seen in FIG. 8 where the optical design seen in FIG. 7 has been modified with the addition of additional polarisers in the separate laser output and return signal paths.

It will be understood that the above description is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations.

Aspects of the invention disclosed here are defined in the following numbered clauses:
1. An optical assembly for a laser projection and return laser light detection device comprising:
   a housing;
   a first series of components arranged in the housing to define an exit path for laser radiation entering from a laser source and then exiting from the housing;
   a second series of components arranged in the housing to define a return path for scattered returns of the laser radiation entering the housing and passing to a detector;
   a polarising beam splitter/combiner common to the exit path and the return path arranged to polarise laser light exiting from the housing and to separate scattered laser light returned to the assembly, that is orthogonally polarised to the exiting laser radiation;
   wherein the polarising beam splitter/combiner forms a window to the housing.
2. The assembly of clause 1 comprising one or more optical components outside the housing forming with the beam splitter/combiner a common exit and return path outside the housing for laser radiation, the one or more optical components being arranged to collect laser radiation entering the housing and to project laser radiation exiting the housing.
3. The assembly of clause 1 or clause 2 wherein the first series of components comprises one or more components arranged to focus laser radiation in the exit path inside the housing so that the laser radiation passing off or though the polariser is spatially diverging.
4. The assembly of any preceding clause wherein the second series of components comprises one or more components arranged to collimate laser radiation in the return path.
5. The assembly of any preceding clause wherein the optical surfaces of the beam splitter/combiner and/or optical surfaces of other optics in the common exit and return path have low-scatter super-polished surfaces.
6. The assembly of any preceding clause wherein the first series of components comprises one or more polarisers in addition to the polariser beam splitter/combiner.
7. The assembly of any preceding clause wherein the second series of components comprises one or more polarisers in addition to the beam splitter/combiner.
8. The assembly of any preceding clause comprising one or more mechanical components arranged to limit the optical path to the detector.
9. The assembly of clause 8 wherein the one or more mechanical components comprise a box surrounding the detector.
10. The assembly of clause 9 wherein the box is designed such that only the end face of the detector is exposed to the interior of the housing.
11. The assembly of any preceding clause comprising an additional wave plate/retarder in the common exit and return path so that a portion of the reflected laser return is passed back to the detector.
12. The assembly of any preceding clause wherein the first series of components comprises a gas reference cell and the second series of components does not comprise a gas reference cell.
13. A transceiver system comprising an optical assembly according to any preceding clause, a laser source and a detector.
14. A laser projection and return laser light detection device comprising a transceiver system according to clause 13.

1. An optical assembly for a laser projection and return laser light detection device comprising:
a housing;
a first series of components arranged in the housing to define an exit path for laser radiation entering from a laser source and then exiting from the housing;
a second series of components arranged in the housing to define a return path for scattered returns of the laser radiation entering the housing and passing to a detector;
a polarising beam splitter/combiner common to the exit path and the return path arranged to polarise laser light exiting from the housing and to separate scattered laser light returned to the assembly, that is orthogonally polarised to the exiting laser radiation;
wherein the polarising beam splitter/combiner forms a window to the housing.

2. The assembly of claim 1 comprising one or more optical components outside the housing forming with the beam splitter/combiner a common exit and return path outside the housing for laser radiation, the one or more optical components being arranged to collect laser radiation entering the housing and to project laser radiation exiting the housing.

3. The assembly of claim 1 wherein the first series of components comprises one or more components arranged to focus laser radiation in the exit path inside the housing so that the laser radiation passing off or though the polariser is spatially diverging.

4. The assembly of claim 1 wherein the second series of components comprises one or more components arranged to collimate laser radiation in the return path.

5. The assembly of claim 1 wherein the optical surfaces of the beam splitter/combiner and/or optical surfaces of other optics in the common exit and return path have low-scatter super-polished surfaces.

6. The assembly of claim 1 wherein the first series of components comprises one or more polarisers in addition to the polariser beam splitter/combiner.

7. The assembly of claim 1 wherein the second series of components comprises one or more polarisers in addition to the beam splitter/combiner.

8. The assembly of claim 1 comprising one or more mechanical components arranged to limit the optical path to the detector.

9. The assembly of claim 8 wherein the one or more mechanical components comprise a box surrounding the detector.

10. The assembly of claim 9 wherein the box is designed such that only the end face of the detector is exposed to the interior of the housing.

11. The assembly of claim 1 comprising an additional wave plate/retarder in the common exit and return path so that a portion of the reflected laser return is passed back to the detector.

12. The assembly of claim 1 wherein the first series of components comprises a gas reference cell and the second series of components does not comprise a gas reference cell.

13. A transceiver system comprising an optical assembly as claimed in claim 1, a laser source and a detector.

14. A laser projection and return laser light detection device comprising a transceiver system as claimed in claim 13.
